(19) United States
(12) Patent Application Publication
(10) Pub. No.: US 2004/0206373 A1
(43) Pub. Date: Oct. 21, 2004

(54) Spin rinse dry cell

(75) Inventors: Bernardo Donoso, San Jose, CA (US); Tetsuya Ishikawa, Saratoga, CA (US); Lily L. Pang, Fremont, CA (US); Svetlana Sherman, San Jose, CA (US)

Correspondence Address: PATENT COUNSEL, APPLIED MATERIALS, INC., Legal Affairs Department, P.O. Box 450A, Santa Clara, CA, 95052, US

(73) Assignee: Applied Materials, Inc.

(21) Appl. No.: 10/680,616

(22) Filed: Oct. 6, 2003

Related U.S. Application Data
(60) Provisional application No. 60/463,862, filed on Apr. 18, 2003.

(51) Int. Cl. B08B 3/02

(52) U.S. Cl. 134/18; 134/26; 134/33; 134/34

(57) ABSTRACT

Embodiments of the invention generally provide a substrate spin rinse dry cell that may be used in a semiconductor processing system. The cell generally includes a cell body defining an interior processing volume, and a rotatable substrate support member positioned in the processing volume. The rotatable substrate support member includes a rotatable hub assembly having a plurality of upstanding substrate engaging members extending therefrom, and a central member positioned radially inward of the plurality of upstanding substrate engaging members, the central member having a plurality of backside fluid dispensing nozzles and at least one backside gas dispensing nozzle positioned thereon. The cell further includes at least one frontside fluid dispensing nozzle positioned to dispense a rinsing fluid onto an upper surface of a substrate supported by the substrate support member, and at least one frontside gas dispensing nozzle positioned to dispense a drying gas into the processing volume, the drying gas being directed toward the upper substrate surface.

### CROSS-REFERENCE TO RELATED APPLICATIONS

This application claims benefit of U.S. Provisional Patent Application Serial No. 60/463,862, filed Apr. 18, 2003, which is herein incorporated by reference.

### BACKGROUND OF THE INVENTION

1. Field of the Invention

The present invention relates to a processing cell for a substrate. More specifically, the invention pertains to a cell for rotating a substrate, such as a substrate for making microchips, at high revolutions. More particularly, embodiments of the invention generally relate to a spin rinse dry cell that may be integrated into an electrochemical processing system.

2. Description of the Related Art

Metallization of sub-quarter micron sized features is a foundational technology for present and future generations of integrated circuit manufacturing processes. More particularly, in devices such as ultra large scale integration-type devices, i.e., devices having integrated circuits with more than a million logic gates, the multilevel interconnects that lie at the heart of these devices are generally formed by filling high aspect ratio, i.e., greater than about 4:1, interconnect features with a conductive material.

The most common conductive material is copper. Copper is conventionally, deposited into substrate interconnect features using techniques such as chemical vapor deposition (CVD) and physical vapor deposition (PVD). However, as interconnect sizes decreased and aspect ratios have increased, void-free interconnect feature fill via conventional metallization techniques becomes increasingly difficult. Therefore, plating techniques, i.e., electrochemical plating (ECP) and electroless plating, have emerged as promising processes for void free filling of sub-quarter micron sized, high aspect ratio interconnect features in integrated circuit manufacturing processes.

In an ECP process, sub-micron sized high aspect ratio features formed into the surface of a substrate (or a layer deposited thereon) are filled with a conductive material. ECP plating processes are generally performed in two stage processes. First, a seed layer is formed over the surface features, generally through PVD, CVD, or other deposition process; and second, the surface features of the substrate are exposed to an electrolyte solution (in the ECP tool), while an electrical bias is applied between the seed layer and a copper anode positioned within the electrolyte solution. The electrolyte solution generally contains ions such as copper sulfate ions to be plated onto the surface of the substrate. The application of the electrical bias causes these ions to be plated onto the biased seed layer, and to fill the interconnect features.

Once the plating process is completed, the substrate is transferred to at least one of a substrate rinsing cell or a bevel edge clean cell. Bevel edge clean cells are generally configured to dispense an etchant onto the perimeter of the substrate to remove unwanted metal plated thereon. A metal-free “bevel” is typically formed around the substrate perimeter from this process. The substrate rinse cells, often called spin rinse dry cells, or “SRD” cells, generally operate to rinse the surface of the substrate (both front and back) with a rinsing solution to remove any excess processing fluids or contaminants therefrom. The SRD cells are also configured to spin the substrate at a high rate of speed in order to spin off any fluid droplets adhering to the substrate surface. Once the remaining fluid droplets are spun off, the substrate is generally clean and dry.

Another challenge with spin rinse dry-type cells is properly positioning the substrate in the cell for processing. For example, given the high rotation rates that are generally required to spin a substrate dry, if a substrate is not properly positioned, it will likely be spun out of the substrate supports during the spinning process, which is likely to cause damage to the substrate and the cell. Therefore, a system is needed for determining whether a substrate is properly positioned within a SRD cell before a spin process is begun. Still further, a sensing system is needed to confirm that a microchip substrate is disposed horizontally onto an upper support surface of a substrate support assembly (or is otherwise properly chucked) before the substrate is secured in the support assembly and a spin process is initiated.

Embodiments of the invention generally provide an improved spin rinse dry cell for an ECP tool.

### SUMMARY OF THE INVENTION

Embodiments of the invention generally provide a spin rinse dry cell that may be used in a semiconductor processing system. The spin rinse dry cell of the invention utilizes a rotatable bevel engaging substrate support configuration that is configured to provide minimal interference with fluid processing. The substrate bevel engaging members are airfoil shaped, so that when the substrate is rotated a minimal amount of air disturbance or turbulence is generated in the processing cell. The cell also includes both frontside and backside fluid dispensing nozzles that require minimal hardware to implement, and therefore, require minimal maintenance to keep in operation.

Embodiments of the invention generally provide a substrate spin rinse dry cell that may be used in a semiconductor processing system. The cell generally includes a cell body defining an interior processing volume, and a rotatable substrate support member positioned in the processing volume. The rotatable substrate support member includes a rotatable hub assembly having a plurality of upstanding substrate engaging members extending therefrom, and a central member positioned radially inward of the plurality of upstanding substrate engaging members, the central member having a plurality of backside fluid dispensing nozzles and at least one backside gas dispensing nozzle positioned thereon. The cell further includes at least one frontside fluid dispensing nozzle positioned to dispense a rinsing fluid onto an upper surface of a substrate supported by the substrate support member, and at least one frontside gas dispensing nozzle positioned to dispense a drying gas into the processing volume, the drying gas being directed toward the upper substrate surface.

Embodiments of the invention further provide a substrate rinsing cell, wherein the cell includes a rotatable hub assembly having a plurality of airfoil shaped finger assemblies extending therefrom, each of the plurality of finger assemblies having an outer pivotally mounted bevel engaging member and an inner fixed substrate supporting member. The cell further includes at least one backside fluid dispensing nozzle positioned to dispense a rinsing fluid onto a backside of a substrate positioned on the hub assembly, and at least one frontside fluid nozzle positioned to dispense a rinsing fluid onto a frontside of the substrate positioned on the hub assembly.

Embodiments of the invention further provide a method for rinsing and drying a substrate. The method generally includes positioning the substrate on a plurality of fixed post members, pivoting a plurality of bevel engaging fingers radially inward to engage a bevel edge of the substrate and remove the substrate from a horizontal surface of the fixed post members, dispensing a rinsing fluid onto at least one of a frontside and a backside of the substrate while rotating the substrate at a first rotation speed to rinse the substrate for a first period of time, and rotating the substrate at a second rotation speed to dry the substrate for a second period of time, wherein the second rotation speed is greater than the first rotation speed.

Embodiments of the invention further provide an improved spin rinse dry cell that utilizes novel circulation breakers above the surface of a flywheel in order to inhibit backflow of rinsing fluid during a substrate rinsing and drying process. The circulation breakers generally define elongated fins that extend from a central hub of the cell towards the outer edge of the flywheel. Preferably, the fins are fixed at one end to the hub, and do not rotate.

Embodiments of the invention further provide a spin rinse dry that includes a substrate sensing apparatus. The sensing apparatus first includes a light emitter disposed at a point outside of the radius of the substrate. The light emitter directs a beam of light above the surface of the substrate. The sensing apparatus next includes a receiver. In one arrangement, the receiver is a non-reflective receiver that senses the presence of the directed light. The receiver is also disposed outside of the radius of the substrate, but at a point diametrically opposite the light emitter. If the substrate is not resting in a horizontal position along an upper surface of the substrate support members, the receiver does not receive the light generated by the light emitter. This tells the system that the substrate is not or cannot be properly secured, and that rotation of the substrate should not commence.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a top plan view of one embodiment of an electrochemical plating system of the invention.

FIG. 2 illustrates an exemplary embodiment of a plating cell used in the electrochemical plating cell of the invention.

FIG. 3A illustrates a partial perspective and sectional view of an exemplary substrate spin rinse dry cell of the invention.

FIG. 3B illustrates a partial perspective and sectional view of another exemplary substrate spin rinse dry cell of the invention.

FIG. 3C illustrates a partial perspective and section view of another exemplary substrate spin rinse dry cell of the invention incorporating circulation breaker fins.

FIG. 4A illustrates a top perspective view of an exemplary substrate engaging finger for the spin rinse dry cell of the invention, wherein the finger is in the closed position.

FIG. 4B illustrates a top perspective view of an exemplary substrate engaging finger for the spin rinse dry cell of the invention, wherein the finger is in the open position.

FIG. 4C illustrates a side perspective view of an exemplary substrate engaging finger for the spin rinse dry cell of the invention, wherein the finger is in the closed position.

FIG. 4D illustrates a side perspective view of an exemplary substrate engaging finger for the spin rinse dry cell of the invention, wherein the finger is in the open position.

FIG. 5 illustrates an enlarged sectional view of an exemplary flywheel assembly of the invention, for supporting a substrate.

FIG. 6 illustrates a top perspective view of a lower portion of the hub assembly from the SRD cell of FIG. 3A.

FIG. 7 illustrates s a cross sectional view of an SRD cell, with a pair of novel circulation breakers placed within the processing volume of the cell.

FIG. 8 illustrates an enlarged cross sectional view of the SRD cell of FIG. 6. An optional substrate sensing system of the present invention is placed thereon.

FIGS. 9A and 9B illustrate a schematic view of a portion of the SRD cell of FIG. 8, with the optional substrate sensing system of the present invention shown. In FIG. 9A, the substrate is in a substantially horizontal position, permitting optical communication between the light emitter and the light receiver. However, in FIG. 9B the substrate is out-of-horizontal, breaking optical communication between the light emitter and the light receiver.

### DETAILED DESCRIPTION OF THE PREFERRED EMBODIMENT

Embodiments of the invention generally provide a multi-chemistry electrochemical plating system configured to plate conductive materials onto semiconductor substrates. The plating system generally includes a substrate loading area in communication with a substrate processing platform. The loading area is generally configured to receive substrate containing cassettes and transfer substrates received from the cassettes into the plating system for processing. The loading area generally includes a robot configured to transfer substrates to and from the cassettes and to the processing platform or a substrate annealing chamber positioned in communication with the loading area. The processing platform generally includes at least one substrate transfer robot and a plurality of substrate processing cells, i.e., ECP cells, bevel clean cells, spin rinse dry cells, substrate cleaning cells, and electroless plating cells.

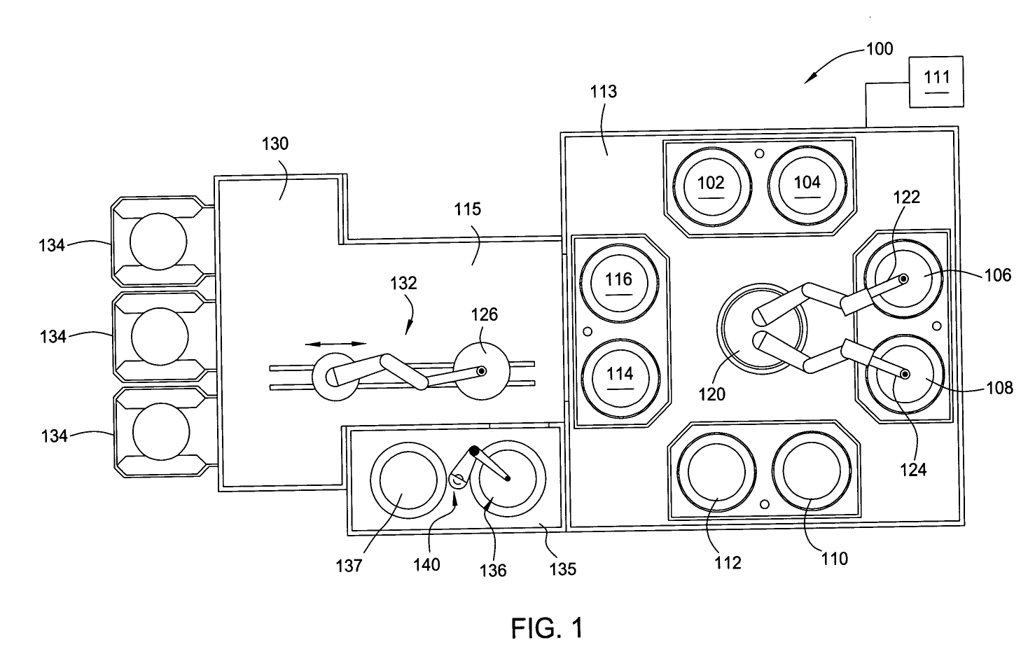

FIG. 1 illustrates a top plan view of an ECP system 100 of the invention. ECP system 100 includes a factory interface (FI) 130, which is also generally termed a substrate loading station. The factory interface 130 includes a plurality of substrate loading stations configured to interface with substrate containing cassettes 134. A robot 132 is positioned in the factory interface 130, and is configured to access substrates contained in the cassettes 134. Further, robot 132 also extends into a link tunnel 115 that connects the factory interface 130 to a substrate processing mainframe or “platform” 113. The factory interface robot 132 thus includes the ability to rotate, extend, and vertically move an attached substrate support blade, while also allowing for linear travel along a robot track that extends from the factory interface 130 to the mainframe 113.

The position of the robot 132 allows the robot 132 to access substrate cassettes positions on loading stations 134, and to then deliver the substrates to one of the processing cell stations shown at 114 and 116 positioned on the mainframe 113. Similarly, the robot 132 may be used to retrieve substrates from the processing cells 114, 116, or transfer substrates to or from an annealing chamber, shown at 135. After a substrate processing sequence is complete, the robot 132 returns the substrates back to one of the cassettes for removal from the ECP system 100. Additional configurations and implementations of an electrochemical processing system are illustrated in commonly assigned U.S. patent application Ser. No. 10/435,121 filed on Dec. 19, 2002 entitled “Multi-Chemistry Electrochemical Processing System”, which is incorporated herein by reference in its entirety.

The anneal chamber 135 generally includes a two position annealing chamber, wherein a cooling plate/position 136 and a heating plate/position 137 are positioned adjacently with a substrate transfer robot 140 positioned proximate thereto, e.g., between the two stations. The robot 140 is generally configured to move substrates between the respective heating 137 and cooling plates 136. Further, although the anneal chamber 135 is illustrated as being positioned such that it is accessed from the link tunnel 115, embodiments of the invention are not limited to any particular configuration or placement. As such, the anneal chamber may be positioned in communication with the mainframe 113. Additional information relative to the anneal chamber of the invention may be found in a commonly assigned U.S. patent application entitled “Two Position Anneal Chamber” naming Edwin Mok and Son Nguyen as inventors. That application bears Serial No. 60/463,860, and is hereby incorporated by reference in its entirety.

As mentioned above, the ECP system 100 also includes a processing mainframe 113. A substrate transfer robot 120 is centrally positioned within the mainframe 113. The robot 120 generally includes one or more arms/blades 122, 124 configured to support and transfer substrates thereon. Additionally, the robot 120 and the accompanying arms 122, 124 are generally configured to extend, rotate, and vertically move so that the robot 120 may insert and remove substrates to and from a plurality of processing stations 102, 104, 106, 108, 110, 112, 114, 116 positioned on the mainframe 113. Generally, processing stations 102, 104, 106, 108, 110, 112, 114, 116 may be any number of processing cells utilized in an electrochemical plating platform. More particularly, the process stations may be configured as electrochemical plating cells, rinsing cells, bevel clean cells, spin rinse dry cells, substrate surface cleaning cells, electroless plating cells, metrology inspection stations, and/or other processing cells that may be beneficially used in conjunction with a plating platform. Each of the respective processing stations and robots are generally in communication with a process controller 111, which may be a microprocessor-based control system configured to receive inputs from both a user and/or various sensors positioned on the system 100 and appropriately control the operation of the system 100 in accordance with the inputs.

In the exemplary plating system illustrated in FIG. 1, the processing stations may be configured as follows. Processing stations 114 and 116 may be configured as an interface between the wet processing stations on the mainframe 113 and the dry processing regions in the link tunnel 115, annealing chamber 135, and the factory interface 130. The processing cells located at the interface stations may be spin rinse dry cells and/or substrate cleaning cells. More particularly, each of stations 114 and 116 may include both a spin rinse dry cell and a substrate cleaning cell in a stacked configuration. Stations 102, 104, 110, and 112 may be configured as plating cells, either electrochemical plating cells or electroless plating cells, for example. Stations 106, 108 may be configured as substrate bevel cleaning cells. Additional configurations and implementations of an electrochemical processing system are illustrated in commonly assigned U.S. patent application Ser. No. 10/435,121 filed on Dec. 19, 2002 entitled “Multi-Chemistry Electrochemical Processing System.” That application is incorporated herein by reference in its entirety.

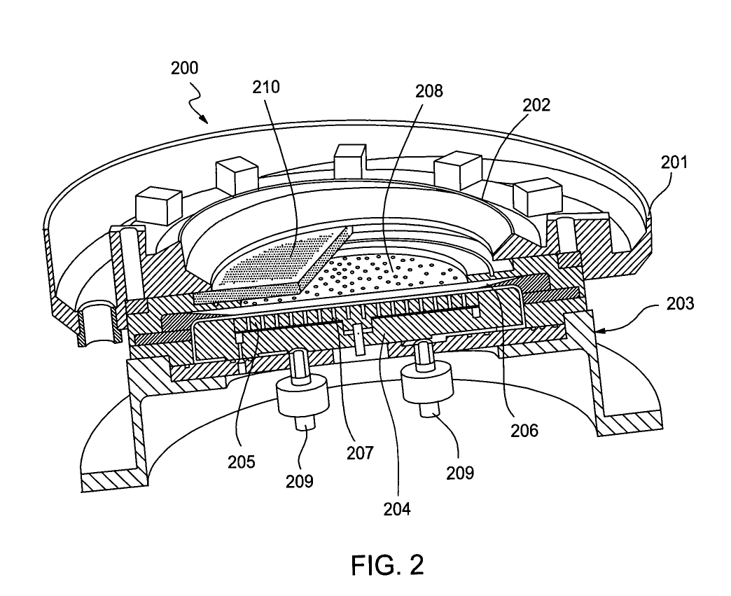

FIG. 2 illustrates a partial perspective and sectional view of an exemplary plating cell 200 that may be implemented in processing stations 102, 104, 110, and 112. The electrochemical plating cell 200 generally includes an outer basin 201 and an inner basin 202 positioned within outer basin 201. The inner basin 202 is generally configured to contain a plating solution that is used to plate a metal, e.g., copper, onto a substrate during an electrochemical plating process. During the plating process, the plating solution is generally continuously supplied to inner basin 202 (at about 1 gallon per minute for a 10 liter plating cell, for example). Because of the continuous solution flow, the plating solution continually overflows the uppermost point (generally termed a “weir”) of the inner basin 202, and must be collected by an outer basin 201. The plating solution is then drained and collected for chemical management and recirculation. Plating cell 200 is generally positioned at a tilt angle, i.e., the frame portion 203 of plating cell 200 is generally elevated on one side such that the components of plating cell 200 are tilted between about 3° and about 30°, or generally between about 4° and about 10° for optimal results. The frame member 203 of plating cell 200 supports an annular base member on an upper portion thereof. Since frame member 203 is elevated on one side, the upper surface of base member 204 is generally tilted from the horizontal at an angle that corresponds to the angle of frame member 203 relative to a horizontal position. Base member 204 includes an annular or disk shaped recess formed into a central portion thereof, the annular recess being configured to receive a disk shaped anode member 205. Base member 204 further includes a plurality of fluid inlets/drains 209 extending from a lower surface thereof. Each of the fluid inlets/drains 209 are generally configured to individually supply or drain a fluid to or from either the anode compartment or the cathode compartment of plating cell 200. Anode member 205 generally includes a plurality of slots 207 formed therethrough, wherein the slots 207 are generally positioned in parallel orientation with each other across the surface of the anode 205. The parallel orientation allows for dense fluids generated at the anode surface to flow downwardly across the anode surface and into one of the slots 207. Plating cell 200 further includes a membrane support assembly 206. Membrane support assembly 206 is generally secured at an outer periphery thereof to the base member 204, and includes an interior region configured to allow fluids to pass therethrough.

A membrane 208 is stretched across the support 206. The membrane operates to fluidly separate catholyte chamber and anolyte chamber portions of the plating cell 200. The membrane support assembly may include an o-ring type seal positioned near a perimeter of the membrane 208, wherein the seal is configured to prevent fluids from traveling from one side of the membrane secured on the membrane support 206 to the other side of the membrane 208. A diffusion plate 210, which is generally a porous ceramic disk member, is configured to generate a substantially laminar flow or even flow of fluid in the direction of the substrate being plated. The diffusion plate 210 is positioned in the cell 200 between membrane 208 and the substrate being plated. The exemplary plating cell is further illustrated in commonly assigned U.S. patent application Ser. No. 10/268,284, which was filed on Oct. 9, 2002 under the title “Electrochemical Processing Cell”, claiming priority to U.S. Provisional Application Serial No. 60/398,345, which was filed on Jul. 24, 2002, both of which are incorporated herein by reference in their entireties.

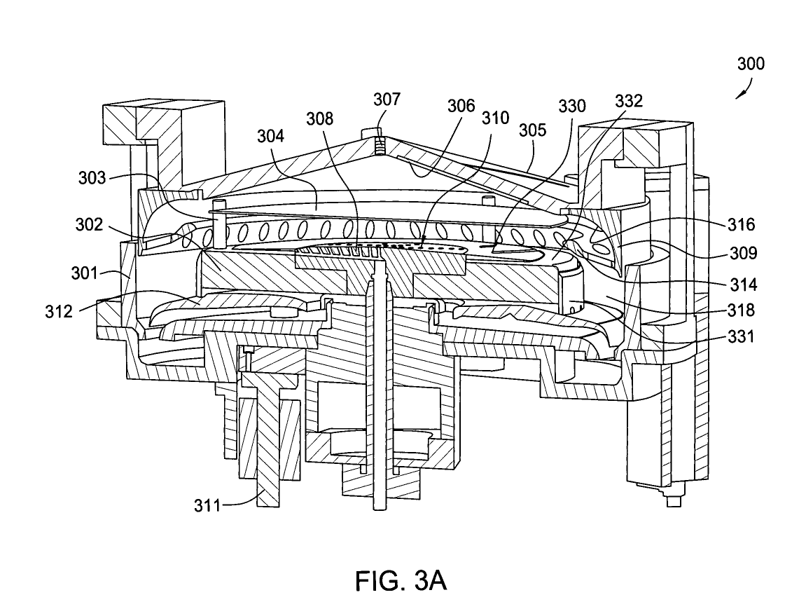

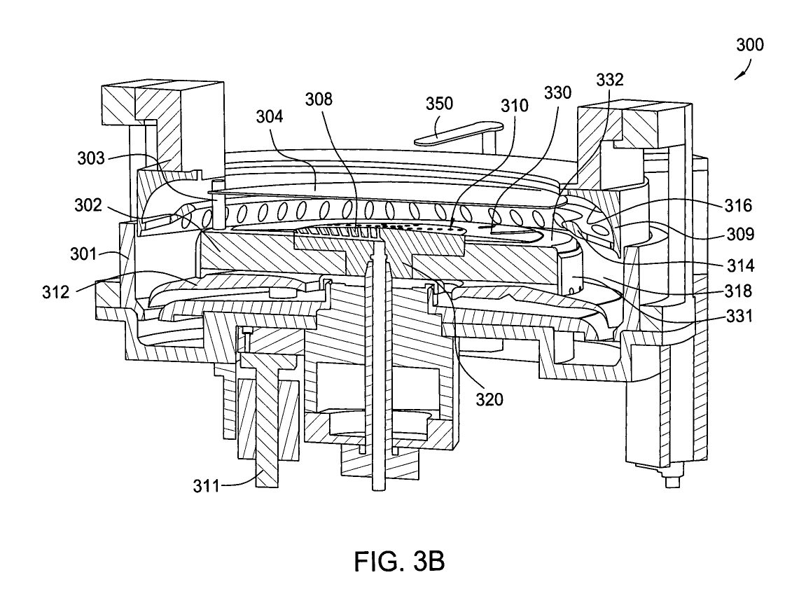

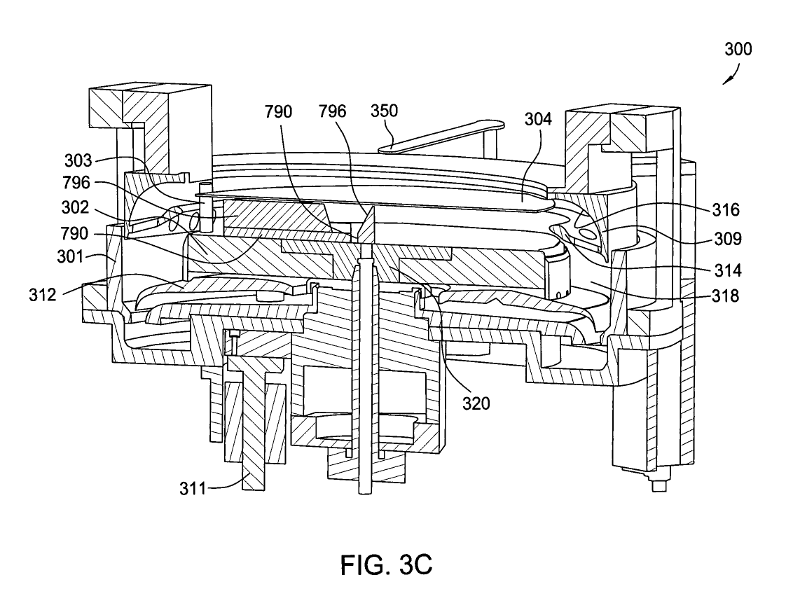

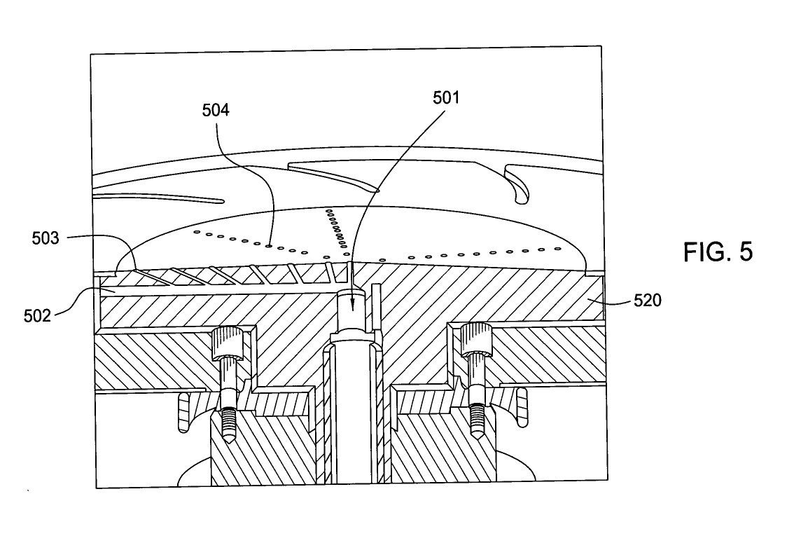

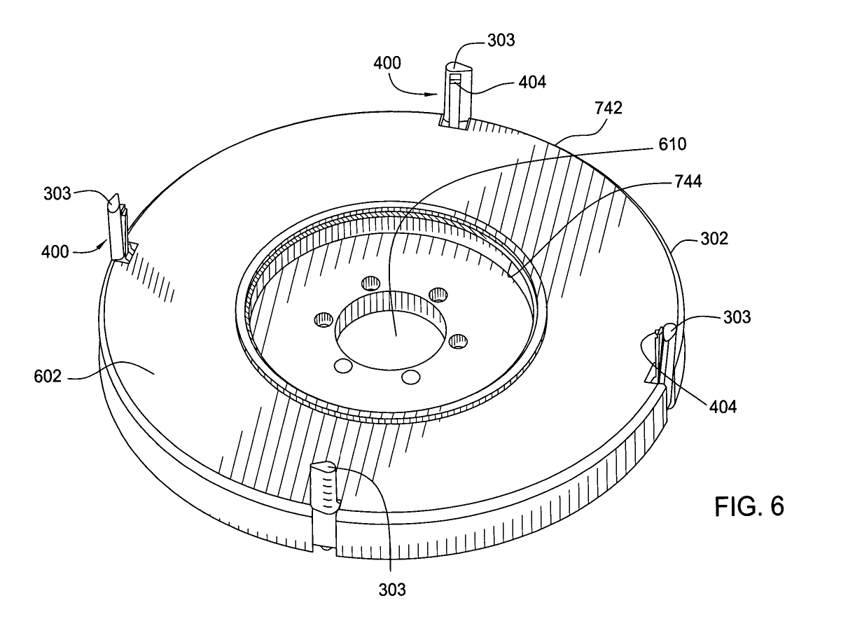

FIG. 3A illustrates a partial perspective and sectional view of an exemplary substrate spin rinse dry cell 300 of the invention. The spin rinse dry cell 300 (SRD) includes a fluid bowl/body 301 supported on a frame that may be attached to a plating system, such as the mainframe 113 illustrated in FIG. 1. The SRD 300 further includes a rotatable flywheel 302 centrally positioned in the fluid bowl 301. The flywheel 302 may include a generally planar or curved upper surface that has a plurality of backside fluid dispensing nozzles 308 formed thereon and at least one gas dispensing nozzle 310 formed thereon (also shown in FIG. 5 as nozzles 503). These nozzles 308, 310 permit fluid, e.g., deionized water, and gas, e.g., N₂ purge gas, to be applied to the back side of a substrate 304. In one embodiment of the invention, flywheel 302 is covered by a horizontal shield 330 on an upper surface thereof, and by a vertical shield 331 on a side or vertical surface thereof. Both shields 330 331 are positioned to be stationary and adjacent to the flywheel 302. More particularly, horizontal shield 330 may be attached to the central hub 520 (illustrated in FIG. 5) and extend radially outward therefrom. Further, shield 330 may be positioned to essentially float above the rotating flywheel 302 with a space between the rotating flywheel 302 and the shield 330 being between about 1 mm and about 5 mm, for example. Similarly, vertical shield 331 may be attached to basin shield member 312 and be positioned to be spaced from a vertical edge of the flywheel 302 by a distance of between about 1 mm and about 5 mm, for example. The positioning of shields 330, 331 is generally configured to minimize the exposed rotating surface area of flywheel 302. More particularly, the exposed surface area 332 of flywheel 302 is a cause of turbulent airflow in cell 300. Since turbulent airflow does not facilitate effective drying of substrates, minimization of turbulent airflow is desired. Thus, in one embodiment of the invention, the exposed rotating surface area of the flywheel 332 is minimized in order to minimize induced turbulence in the airflow within the cell 300.

A plurality of upstanding substrate engaging fingers 303 are positioned radially around the perimeter of flywheel 302. Generally, fingers 303 are airfoil shaped when viewed from the top, so that the fingers 303 will generate minimal turbulence when flywheel 302 is rotated. In the illustrated embodiment of the invention, four fingers 303 are shown (see FIG. 6), however, the invention is not limited to any particular number of fingers. Fingers 303 are configured to rotatably support a substrate 304 at the bevel edge thereof for processing in SRD 300. Together, the flywheel 302 and the substrate engaging fingers 303 serve as a rotatable substrate support member. However, other embodiments may be provided where the engaging fingers 303 are connected to the side wall or other components of the cell than a flywheel.

The upper portion of SRD 300 may include a lid member 305, which is generally dome shaped, that operates to enclose a processing space below the dome 305 and above the flywheel 302. Further, dome member 305 includes at least one gas nozzle 307 positioned therein that is configured to dispense a processing gas into the processing space, and a fluid manifold 306 configured to dispense a processing fluid therefrom onto the substrate 304 secured to the fingers 303. At least one side of the SRD 300 includes a door or opening (not shown) that may be selectively opened and closed to provide access to the processing area of SRD 300. The lower portion of SRD 300 includes an annular basin shield member 312 positioned around the perimeter of the basin. The shield 312 is positioned below and radially outward of the flywheel 302, and therefore, is configured to shed fluid outwardly to the perimeter of the basin. Additionally, shield 312 is configured to be vertically actuatable, as will be further discussed herein.

In another embodiment of the invention, the processing volume is not confined at an upper portion by a lid or upper member. In this embodiment, the processing cell 300 would include a lower drain basin and upstanding side walls, however, the upper portion of the processing space would generally be open. Further, in this embodiment the fluid dispensing nozzle or manifold would generally be positioned or mounted on an upstanding side wall portion of the cell 300. For example, a fluid dispensing arm (shown at 350 in FIG. 3B) may be pivotally mounted to the side wall, or a structure positioned outside of the cell 300, such that a distal end of the arm having a fluid dispensing nozzle positioned thereon may be pivoted to a position over a substrate 304 being processed in the cell 300. The pivotal motion of the arm 350 is generally in a plane that is parallel and above the substrate 304 being processed. The pivotal movement of the arm 350 allows the nozzle positioned on the end of the arm 350 to be positioned over specific radial positions on the substrate, i.e., over the center of the substrate or over a point that is a specific radius from the center of the substrate 304, for example. Aside from the repositioning of the fluid dispensing nozzle, this embodiment of the invention is structurally similar to the previous embodiment and functions in a similar manner.

FIG. 3B illustrates a partial perspective and sectional view of an exemplary substrate spin rinse dry cell having an open top. In this embodiment of the invention, the SRD cell 300 is substantially similar to the cell 300 illustrated in FIG. 3A, except that the SRD cell 300 illustrated in FIG. 3B does not include a lid 305. As such, the SRD cell illustrated in FIG. 3B is not enclosed during the rinsing process. Another difference between the SRD cell illustrated in FIG. 3A and the embodiment illustrated in FIG. 3B is that the SRD illustrated in FIG. 3B includes a pivotally mounted fluid dispensing nozzle 350, which operates to replace the fluid dispensing manifold 306 formed into the lid 305. The nozzle 350 is configured to pivot outward over the substrate surface and dispense a processing fluid, generally deionized water, onto the substrate surface proximate the center of the substrate. Additionally, an upper cell wall 309, along with the attached catch cup 314 and curved surface 316 may be raised and lowered to facilitate loading and unloading of substrates. For example, when a substrate is loaded, upper wall 309 may be lowered to allow for access to the substrate engaging fingers 303. When processing begins, then wall 309 may be raised to position the catch cup 314 and curved wall 316 next to the substrate so the that the fluid spun off of the substrate may be captured and airflow over the perimeter of the substrate controlled, as will be further discussed herein.

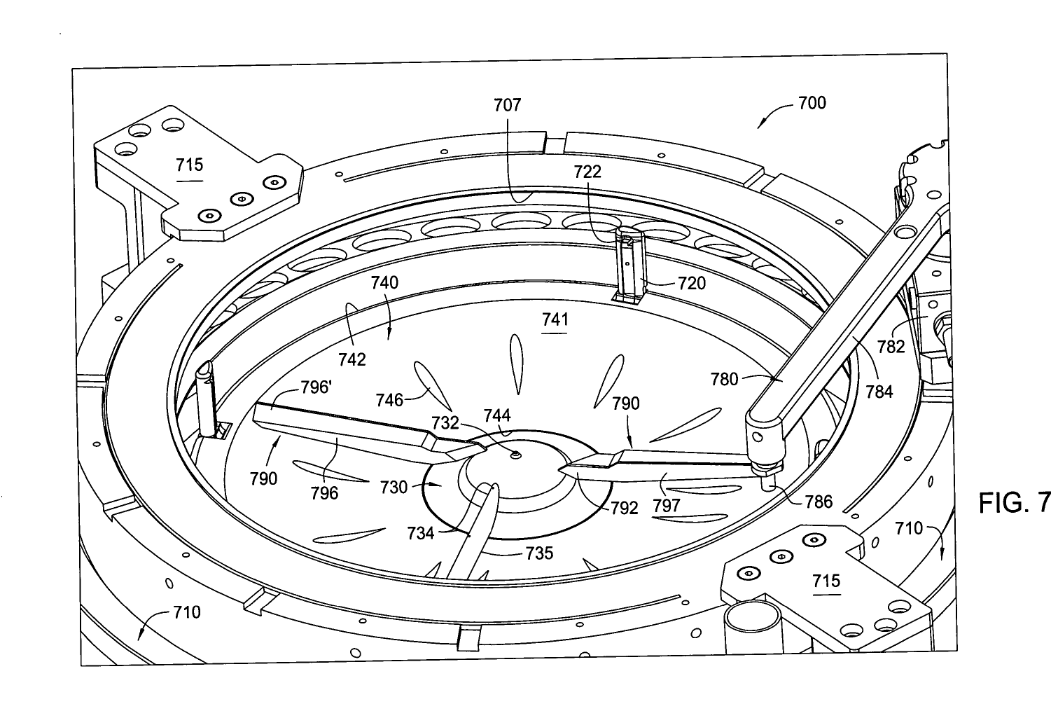

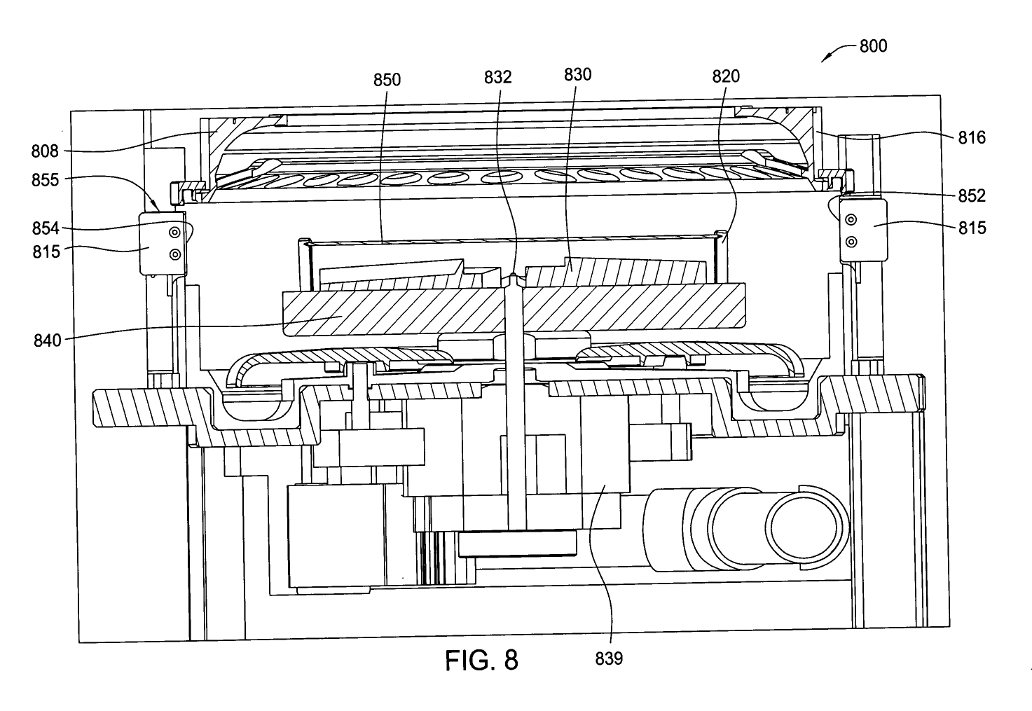

FIG. 3C illustrates another embodiment of an SRD cell 300. However, cell 300 illustrated in FIG. 3C includes circulation breaker fins 794, which will be further discussed herein with respect to FIGS. 7 and 8. The fins 794 operate in the same manner in the cell 300 illustrated in FIG. 3C as described with respect to FIGS. 7 and 8, i.e., to reduce the cyclonic effect between the substrate 304 and the flywheel 302 near the center, which minimizes redeposition of fluids onto the substrate as a result of the cyclonic effect during rotation dry steps.

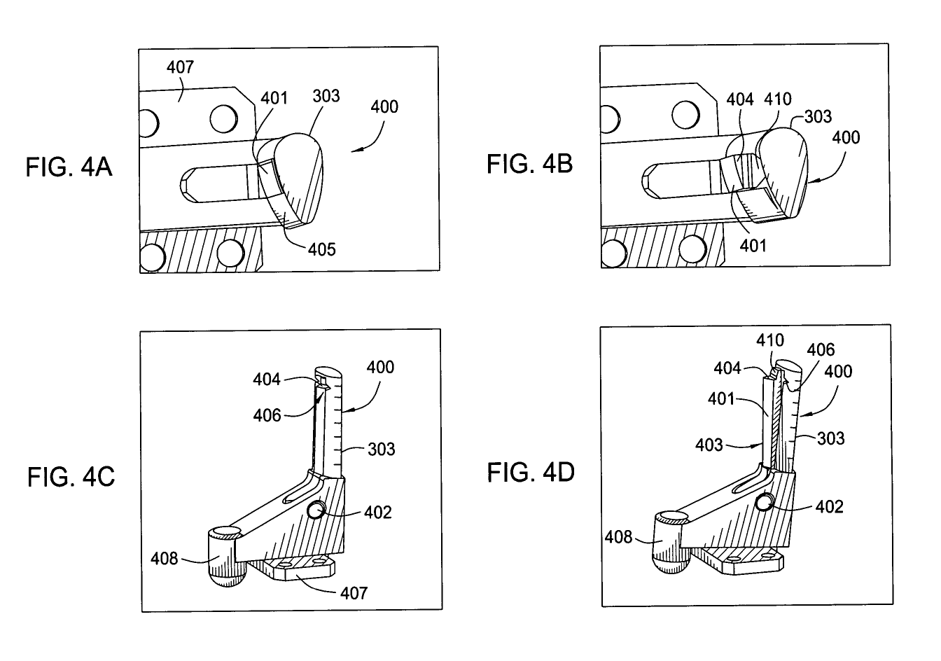

FIGS. 4A-4D illustrate more detailed views of the substrate engaging fingers 303 of the exemplary SRD cell 300. More particularly, FIG. 4A illustrates a perspective view of an exemplary substrate support assembly 400 in a closed position. The particular substrate support assembly 400 of FIG. 4A generally includes a base 407 having an upstanding pivotally mounted support finger 303 extending therefrom. The support assembly 400 further includes a lower actuator portion 408 positioned inward of the upstanding finger 303, as illustrated in FIG. 4C. The actuator 408 is pivotally mounted about a pivot point 402, and is generally balanced to be dynamically stable relative to the pivot point 402 during rotation, i.e., the finger portion 303 is not urged inwardly or outwardly by rotation as a result of the balance of the assembly 400. The exemplary support finger 303 is generally a wing-shaped member when viewed from the top. In this way the finger 303 is configured to be aerodynamically rotated within the processing space, generating a minimal amount of airflow disturbance or turbulence. The leading edge of the finger 303, i.e., the side that the air first contacts when the substrate support assembly 400 is rotated, is generally rounded to provide a minimal drag and turbulence path. This inhibits unwanted airflows in the processing space. The trailing edge of the finger 303, i.e., the edge opposite the rounded or leading edge, is generally smaller in cross section than the rounded edge. The leading edge and the trailing edge are connected by a generally smooth and sometimes arcing or curving surface 405. The smooth surface 405 includes a horizontally oriented notch 406. The notch 406 is sized and configured to receive and engage the bevel edge of a substrate 304 during processing. The notch 406 generally extends horizontally in a direction that is orthogonal to the vertical axis of the substrate support assembly 400.

Substrate support assembly 400 further includes an inner fixed post 401 that is rigidly attached to the base member 407. Posts 401 extend upward through an exposed channel formed into the inner surface 405 of the pivotally mounted fingers 303. Thus, posts 401 remain stationary, while fingers 303 are pivotally mounted via pivot member 402, as illustrated in FIG. 4C. Further, the upper terminating end of post 401 includes a substrate supporting surface 404 formed thereon. The support surface 404 includes a generally horizontal portion configured to support a substrate thereon, and a vertical or angled portion 410 positioned radially outward of the horizontal portion to maintain the substrate at a position radially inward of the post 401 and to guide the substrate onto the support surface 404.

FIG. 4B illustrates a top perspective view of the support assembly 400 in an open or loading position. More particularly, when the support assembly 400 is in the open position, the finger 303 is pivoted outward such that the upper support surface 404 of the fixed post 401 is exposed. The finger 303 may be pivoted to this position via movement of the actuator portion 408 upward. This movement causes the upper terminating end of the finger 303 to pivot outward as a result of the placement of the pivot point 402. The result of the pivotal movement of the finger 303 is that the upper substrate supporting surface 404 of the post 401 is positioned such that a substrate 304 may be positioned thereon.

FIG. 4D illustrates the support assembly 400 in the open position from a side view, which illustrates how the upper surface 404 of post 401 extends from the finger 303 such that the substrate support surface 404 is positioned to support the edge of a substrate. FIG. 4C illustrates a side perspective view and FIG. 4A illustrates a plan view of the finger assembly in the closed or processing position. The closed position generally corresponds to a position of the post 401 relative to the finger 303 where the substrate 304 is secured to the flywheel 302 (via fingers 303) for processing. Similarly, the open position generally corresponds to the position of post 401 relative to the finger 303 where the upper substrate support portion 404 of post 401 is positioned to receive a substrate thereon. Thus, the open position is essentially a substrate loading position and the closed position is essentially a substrate processing position. In the closed position (FIGS. 4A and 4C) the substrate is supported at the bevel edge by the horizontal notch 406 of the finger 303, which is pivoted inward about pivot point 402 to engage a substrate for processing.

The process of actuating the finger members 303 generally includes mechanically engaging and vertically moving the lower actuator portion 408. For example, vertical or upward movement of the lower actuator portion 408 causes the finger 303 to pivot outward to expose the substrate support post 401. The lower actuator portion 408 is vertically actuated via vertical actuation of the shield member 312, which is positioned to mechanically engage the lower actuator portion. Thus, when the substrate is being loaded onto the substrate support assembly 400, shield 312 is raised to open the fingers 303 to a substrate receiving/loading position. Once the substrate is loaded, then shield 312 may be lowered and the substrate engaged by notches 406 for the rinsing and drying process. The unloading process may be conducted in substantially the same manner.

FIG. 5 illustrates a partial and enlarged sectional view of a hub 520. The hub 520 resides within the central opening of the rotatable flywheel 302 of FIG. 2. The interior portion of hub 520 includes a conduit 501 configured to communicate a rinsing fluid to a plurality of fluid dispensing apertures 503 formed onto the upper surface 504 of the hub 520 via a fluid dispensing manifold 502. Additionally, hub 520 generally includes a second conduit (not shown) formed therein that is configured to communicate a drying gas to a plurality of gas dispensing purge ports 504. Further, embodiments of the invention contemplate that the fluid and gas conduits may be combined into a single conduit, wherein a valve assembly is used to switch between fluid and gas supplied to the single conduit.

FIG. 6 illustrates a top perspective view of a substrate support member, including a flywheel 302. More particularly, although flywheel assembly 302 may be a unitary element, embodiments of the invention also contemplate that the flywheel 302 may include separate elements that rotate independently. For example, FIG. 6 illustrates an exemplary lower portion of a flywheel 302. The exemplary lower portion is generally a disk shaped member having a central aperture 610 formed therein. The outer portion of the lower disk shaped member includes an upper planar surface 602 and the plurality of substrate engaging fingers 303 positioned radially around the perimeter. In this configuration, the gas and fluid delivery apertures 503, 504 formed into hub 520, as illustrated in FIG. 5, may be positioned in the central aperture 610. In this configuration, hub 520 may be fixed, while the flywheel 302 may rotate with respect to the fixed inner hub 520. This allows the fluid and gas dispensing nozzles to dispense their respective fluids over the entire area of the substrate, as the respective members are rotating relative to each other, i.e., hub 520 is stationary and flywheel 302 rotates.

In operation, the spin rinse dry cell 300 generally operates to receive a substrate therein, rinse the substrate with a rinsing fluid, and dry the substrate via spinning the substrate to centrifugally urge fluid off of the substrate surface, while also dispensing a drying gas into the cell containing substrate to further facilitate the drying process. A substrate may be positioned in the cell 300 via a door or opening, which may be positioned on one side of cell 300, or alternatively, cell 300 may include more than one door positioned on, for example, opposing sides of the cell, such that substrate may be brought into cell 300 on one side and taken out of cell 300 on another side. Substrates are generally positioned in cell 300 by a substrate transfer robot, such as robot 120 or robot 132 illustrated in FIG. 1. Robots generally support the substrates from the underside, and therefore, when the substrate is transferred into the cell 300, it is generally positioned above the fingers 303. The fingers 303 are actuated to the open position, i.e., the position where the upper surface 404 of the fixed post 401 is exposed. With the upper surface 404 exposed, the robot may lower the substrate onto the plurality of fingers 303 such that the substrate is supported by the upper surface 404 of each of the fingers 303. The upper portion of the fixed posts may include an inwardly inclining surface 410 that is configured to guide the substrate inwardly or center the substrate on the respective posts 401. Once the substrate is positioned on the horizontal surfaces 404, the robot blade may retract from cell 300 and the door may be closed to isolate the interior processing volume of cell 300 from the ambient atmosphere.

Once a substrate 304 is positioned on the upper surface 404 of the substrate engaging fingers 303, the substrate engaging fingers 303 may be actuated to engage the bevel edge of the substrate. More particularly, the lower portion 408 of fingers 303 may be actuated downward, thus causing the upper terminating end of finger 303 to pivot inwardly towards the substrate supported on surface 404. As the upper terminating end of the finger 303 pivots inwardly, the horizontal notch 406 (illustrated in FIGS. 4C and 4D) engages the bevel edge of the substrate 304, thus securing the substrate 304 between the respective substrate engaging fingers 303. The engagement of the bevel edge of the substrate by the notches 406 removes the substrate 304 from being solely supported by the upper surfaces 404 of the fixed post members 401, and prepares the substrate 304 for rotation via engagement of the bevel edge by the horizontal notches 406, which are configured to minimally contact the substrate surfaces.

Those of ordinary skill in the art will appreciate from the present disclosure that tolerances for placing a substrate 304 onto a set of substrate support members, such as substrate support assembly 400, are quite fine. If the robot does not properly place a substrate onto a support member, the substrate will not be horizontal during the rinsing and spinning processes. This, in turn, inhibits the drying process and presents a safety hazard, as a tilted substrate is likely to be dislodged from the support fingers and cause damage to the cell and/or operator. Moreover, if the substrate is not adequately secured during the spin process, the substrate will create unwanted vibrations within the ECP system 100. Ultimately, the substrate may be flung about within the SRD cell 300, causing irreparable damage to an expensive substrate and/or the cell 300 components.

Once the substrate is secured to the substrate support assembly 400, processing may begin. Generally, processing in cell 300 will include rinsing and drying the substrate positioned therein. The rinsing and drying processes generally includes rotating the substrate, and therefore, fingers 303 are generally secured to a rotatable-type flywheel 302, as illustrated in FIG. 3. Once the substrate is rotating, fluid dispensing nozzles may dispense a rinsing fluid onto the front, back, or both sides of the rotating substrate. Fluid dispensed onto the front side of the substrate may be dispensed by manifold 306 positioned in the lid member 305 (or arm 350), while fluid is dispensed to onto the back side of the substrate may be dispensed by the fluid apertures 503 formed into the flywheel 302. Although various rinsing solutions suitable for semiconductor processing are contemplated within the scope of the invention, DI and other etchant/cleaning solutions are examples of fluids that may be dispensed onto the substrate in order to rinse and/or clean the surface thereof. Further, and since the substrate is rotating during the process of dispensing the rinsing fluid thereon, the fluid is generally urged radially outward toward the perimeter of the substrate. In this manner that fluid flows off of the bevel edge of the substrate and is collected in the bottom of cell 300. Higher rotation speeds of the flywheel 302 will cause the fluid to flow outward and off of the substrate surface in a nearly horizontal manner, while lower rotation speeds may be used to allow the rinsing fluid to travel outward across the surfaces of the substrate and slightly wrap around the bevel of the substrate before being spun off by centrifugal force.

Once the substrate is rinsed for a predetermined period of time, the rinsing process may be discontinued. This generally corresponds to discontinuing the rinsing fluid flow to the substrate, however, generally, the substrate rotation is generally maintained after the rinsing fluid dispensing process is terminated. This continual rotation operates to urge any remaining droplets of the rinsing fluid that may be adhering or clinging to the substrate surface radially outward and off of the substrate surface. Further, a drying gas may be dispensed into the processing area and directed to the substrate surface in order to further facilitate the removal of any remaining fluid from the substrate surface. For example, nitrogen may be dispensed into the processing volume via the upper purge nozzle 307 and the lower purge apertures 504 while the substrate is being spun dry.

Once the drying process is complete, the substrate may be removed from the cell 300. This process generally includes reversing the substrate entry process, and more particularly, generally includes opening one of the doors to allow access to the substrate by a robot. Once the door is opened, a robot blade may enter into the processing volume below the substrate and be brought into a position proximate the substrate. The substrate engaging fingers 303 may then be actuated to the open position, i.e., actuator 408 may be urged upward such that the upper terminating end of substrate support assembly 400 is pivoted outward to disengage the substrate from the horizontal notch or slot 406. The substrate may then be positioned on the upper surface 404 of the inner fixed posts 401. The robot blade may then be actuated upward to lift the substrate off of surfaces 404 and remove the substrate from the processing volume via the door.

However, one phenomenon that has been observed in spin rinse dry-type cells is that the rotation of the substrate at speeds in excess of 500 rpm has been shown to generate a region of reduced pressure under the substrate and proximate the center of the rotating substrate. Further, when a drying gas is introduced into the region below the substrate, by nozzle 732, for example, the introduction of the gas initiates a cyclonic effect in the airflow near the center of the substrate within the reduced pressure region. This cyclonic effect generates an inwardly and upwardly directed airflow pattern, i.e., air flows toward the center of the hub 730 along the surface thereof and is urged upward near the center of hub 730 toward the substrate. This inwardly and upwardly directed airflow has been shown to carry droplets of processing fluid that are residing on the hub 520 or flywheel surface 602 inward and upward, and as such, cause these fluids to redeposit on the substrate being dried. This redepositing of processing fluid onto the backside of the substrate during the drying process is addressed by the embodiment of the invention illustrated in FIGS. 7 and 8 via implementation of circulation breaker bars, which will be further discussed herein.

FIG. 7 illustrates a perspective view of another embodiment of a spin rinse dry cell 700 of the invention. A substrate is not shown in FIG. 7, however, it is understood that the SRD is sized and configured to receive a substrate, such as substrate 304 shown in FIG. 3A, for rinsing and drying. The cell 700 of FIG. 7 is shown as an “open” cell, meaning that it is not enclosed by a hood or lid. However, the scope of the present invention is not limited to an open cell, but includes closed cells as well. The exemplary SRD cell 700 of FIG. 7 is shown as an open cell simply for aid of viewing components of the cell 700. In the perspective view of FIG. 7, it can be seen that the SRD cell 700 first includes a cell body 710. The cell body 710 is typically circular in nature, and is dimensioned to contain other components used in spinning, rinsing, and drying a substrate. Thus, the cell body 710 defines an interior substrate processing volume. The cell body 710 is fixed to a frame (not shown), that in turn is connected to a processing system platform, such as the mainframe 113 of FIG. 1. The mainframe, in turn, is generally part of a larger substrate processing system. An example of such a system is the ECP system 100 shown in FIG. 1 and described above.

The cell body 710 is secured to the platform or frame by mounting brackets 715. In one embodiment, the brackets 715 are configured to raise an upper portion 707 of the cell body 710 to allow for access to the processing volume. During processing, the upper portion 707 functions with the cell body 710 to define the processing volume of the cell 700. Thus, for purposes of the present disclosure, the term “cell body” means any structure that, at least in part, defines the processing volume of the cell. In the arrangement of FIG. 7, a pair of opposing brackets 715 is shown. The cell body 710 may include a door, or “slot” to allow access to the processing volume. In embodiments where the upper portion 707 is not movable to allow access to the processing volume, an access slot (not shown) may be used. The slot is provided as an opening through which the substrate may be introduced into and removed from the cell 700.

The SRD cell 700 next includes a base, or “flywheel” 740. The flywheel 740 is a circular structure that rotates within the cell body 710. A spindle motor (not shown) is provided under the cell body 710 for rotating the flywheel 740. The flywheel 740 has an outer diameter 742 and an inner diameter 744. The outer diameter 742 has a radius that generally follows the radial dimension of the surrounding cell body 710. At the same time, the inner diameter 744 forms a central opening (illustrated in FIG. 6). The flywheel 740 has a top surface 741 that sits below the substrate during a processing operation. The top surface 741 is preferably sloped to more readily allow rinsing fluids to flow there from, and more particularly, surface 741 may be sloped to urge fluids thereon into drains 746.

It should be noted that, in operation, the flywheel 740 does not retain rinsing fluids. Rather, it catches the fluids as they fall from the bottom surface, i.e., “backside,” of the substrate during a rinsing process. A plurality of drain holes 746 are typically provided around the surface 741 of the flywheel 740. Fluids fall through the drain holes 746, where they are then captured by a frame base member (not shown) or other device, and transported to a fluids collection and/or management system.

The SRD cell 700 next includes at least three, and preferably four, substrate support members 720 (also shown as engaging fingers 303 in previous embodiments). The substrate support members 720 are supported by a rotatable base. In the arrangement shown in FIG. 7, the rotatable base is the flywheel 740. In this respect, the substrate support members 720 are disposed radially around the outer diameter 742 of the flywheel 740. Preferably, the substrate support members 720 are spaced equidistantly around the outer diameter 742 of the flywheel 740. Together, the flywheel 740 and the attached substrate support members 720 form a rotatable substrate support structure. However, the scope of the present invention permits other arrangements for a rotatable base and for disposing substrate support members 720 there around.

The substrate support members 720 are each configured to include an upper support surface 722 for receiving and supporting a substrate. The upper support surface 722 provides a horizontal ledge on which the substrate may be loaded prior to processing in the SRD cell 700. The substrate support members 720 are preferably configured to operate as the substrate support assembly 400 shown in FIGS. 4A through 4D. In this respect, the support members 720 preferably each include a notch 404 that secures the substrate in a locked position before any spin operation is commenced. To this end, the support members 720 rotate with the flywheel 740 during substrate processing. The support members 620 are preferably designed to move between an open position, where a substrate may be received, and a locked position where the substrate is secured for acceleration, high speed rotation and deceleration.

At the center of the flywheel 740 within its inner diameter 744 is a hub 730. The hub 730 is preferably stationary, meaning that it does not rotate relative to the flywheel 740. The hub 730 is supported by a shaft below the hub 730. The shaft typically extends below the cell body 710. The shaft is not shown in the perspective view of FIG. 6, but may be configured in accordance with shaft 320 in FIG. 3. The shaft typically receives and supports fluid channel members (not shown) that transport liquid and gas materials. These channels empty into the surface of the hub 630 as nozzles 732, 734. Nozzle 732 is provided proximate to the center of the hub 730, and generally serves as a gas nozzle. The gas nozzle 732 supplies a purge gas, such as nitrogen, helium, argon or other inert gas, during the drying operation. In addition, one or more fluid nozzles 734 are provided. In the exemplary arrangement of FIG. 7, the fluid nozzles 734 are dispensed in a fluid delivery arm 735 that extends outward from the hub 730. Fluid streams are dispensed through a port proximate to the center of substrate 750, and at two other locations increasingly away from the substrate center to provide satisfactory cleaning coverage. The fluid nozzles 734 dispense rinsing fluid, such as deionized water (H₂O₂), or chemicals (e.g., H₂SO₄) for the rinsing process.

An upper dispensing arm 780 is also shown in FIG. 7. The upper dispensing arm 780 serves to deliver fluids to the top side of the substrate during rinsing. The upper dispensing arm 780 includes a lower pivoting arm 782 mounted offset from the cell body 710. The upper dispensing arm 780 also includes an upper delivery arm 784. The delivery arm 784 includes a fluid nozzle 786 at a distal end. In operation, the delivery arm 784 is moved across the upper surface of the substrate after it has been loaded into the SRD cell 700. In this manner, a rinsing fluid may also be delivered to the top surface of the substrate.

Finally, FIG. 7 shows that the SRD cell 700 includes one or more novel flow circulation control/breaker fins 790. In the embodiment shown in FIG. 7, the fins 790 each have a proximal end 792 connected to the hub 640. Connection is preferably by means of chemical bonding or heat-induced adhesion. The fins 790 also each have a distal end 794 that extends towards the outer diameter 742 of the flywheel 740. It is preferred that two fins 790 be employed, and that the fins 790 be placed on diametrically opposite sides of the hub 730, as shown in FIG. 7. It is also preferable that the fins 790 be linearly configured in their respective radial directions. However, variations from these design preferences are tolerated.

In one arrangement of the fins 790, the fins 790 have a leading side 796 and a back side 797. The leading side 796 of the fins 790 is configured, in one embodiment, to include a beveled or chamfered edge 796′. This aids in the aerodynamic properties of the fins 790 relative to the flywheel 740 and minimizing fluid accumulation on the top edge of fins 790.

The fins 790 are designed to serve as flow circulation breakers. To this end, and as noted above, it has been observed that during the rinse and spin processes, fluid may be inhibited from moving radially outward by the generation of a region of low pressure near the center of the substrate as a result of the rotation of the substrate and flywheel assembly. At lower rotational speeds, when fluid is injected into the center of a rotating substrate on the top side of the substrate, the fluid is urged radially outward along the surface of the substrate until it reaches the bevel edge, where it is then spun off of the substrate by centrifugal force. However, when fluid is directed to the backside of the substrate while the substrate is rotating, e.g., rotating at speeds in excess of 500 rpm, a region of low pressure forms near the center of the substrate. Further, when the drying gas in dispensed into the volume between the substrate and flywheel (generally near the center), a cyclonic air flow pattern (a spiraling and inwardly traveling airflow) generally forms in the low pressure region. This cyclonic airflow pulls air inward toward the low pressure region along the flywheel surface and upwardly toward the substrate. The air is then urges outward toward the substrate perimeter. This inward flow of air near the flywheel generally accumulates fluid, e.g., droplets of fluid that may be present on the flywheel surface, during the inward airflow motion. The airflow then carries these droplets upward toward the substrate, where the fluid droplets are prone to redeposit on the substrate surface. When this occurs, the drying process is impeded and the required process spin time is increased.

Laboratory studies have revealed that the placement of at least one fin 790, or “circulation breaker,” inhibits the cyclonic airflow (specifically the inwardly directed cyclonic airflow) and increases the pressure near the center of the hub 630. Further, the fin 790 also operates to shift the low pressure region from the center of the substrate to the area immediately behind the fin 790, which does not cause inwardly traveling airflow. The at least one fin 790 generally has a rotational speed that is lower than the rotational speed of the substrate 750. Preferably, the at least one fin 790 is stationary. The presence of at least one fin 790 serves to block the back flow of mist during a high speed spin operation by dampening the cyclonic effect. When the fins 790 are connected to the hub 630, the fins 690 aid in evenly distributing pressure below the substrate 750.

In order to effectuate the fins' 790 function, the fins 790 are floated just above the top surface 741 of the flywheel 740. In one embodiment, the fins 790 are affixed to the hub 730 so that the fins 790 float between about 1 mm and 2 mm above the surface 741 of the flywheel 740. In addition, the fins 790 are dimensioned, in one embodiment, to leave a clearance between the top edge of the fins 790 and the backside of the substrate of between about 10 mm and about 20 mm, preferably about 15 mm. This means that the fins 790 are generally between about 25 mm and about 30 mm in height at their points of greatest height. The length of the fins 790 is dependent on the size of the substrate being processed. The SRD cell 700 is typically configured for processing either 200 mm or 300 mm substrates. In either event, the fins 790 are preferably of such a length that a space of between about 15 mm and about to 20 mm is reserved between the distal end 799 of the fins 790 and the substrate support assemblies 720. Regardless, fins 790 are generally sized to vertically extend between about 30% and about 90% of the distance between the flywheel 740 and the bottom of the substrate.

The fins 790 are generally fabricated from a material that is compatible with ECP solutions. In this respect, an ECP solution is oftentimes acidic. An example of such a material is Ultem 1000™ polyetherimide (PEI) manufactured by Quadrant EPP out of Reading, Pa. This material can tolerate higher temperatures, e.g., greater than 300° F., has a high dielectric strength, and is highly resistant to acidic solutions. However, it is understood that any plastic compatible with acid solutions is generally acceptable for fins 790.

An additional novel feature that is incorporated into the improved SRD cell 700 of the present invention is a substrate sensing system 810. The components of the substrate sensing system 810 are seen in the side view of FIG. 8. FIG. 8 presents a partial cross-sectional side view of an SRD cell 800 in an alternate arrangement. The SRD cell 800 is generally configured in accordance with the SRD cell 700 described above, however, a substrate 850 has been placed in the cell 800 for processing. In addition, a substrate sensing system 855 is incorporated.

Referring to FIG. 8, the SRD cell 800 includes a number of components previously described in connection with FIG. 7, including a cell body 810, a shield 808, shield supporting brackets 815, a flywheel 840, a hub 830, substrate support fingers 820, fins 830, and a purge gas nozzle 832. In addition, the SRD cell 800 includes a fluid shaft 890 with a plurality of fluid dispensing nozzles thereon (not shown). In one arrangement, the shield 808 is mounted on two pneumatic actuators with flexible connecting brackets and moves down into the chamber bowl cavity (not shown) during substrate transfer, thus preventing any liquid from dripping outside of the SRD cell 700. A fluid shaft 839 serves to house fluid and gas conduits for the cell 800. A shield 808 is simply a protective guard against a substrate that might become dislodged during a high speed spinning process.

As noted above, the SRD cell 800 of FIG. 8 also contains a novel substrate sensing system 855. The sensing system 855 is designed to sense whether a substrate has been placed on the substrate support members 820 in an essentially horizontal manner. This, in turn, informs the cell control system (seen at 111 in FIG. 1) whether it is safe to commence rinsing, spinning and drying operations.

The novel substrate sensing system 855 generally includes a light emitter 852 and a light receiver 854. The light emitter 852 and the light receiver 854 are preferably affixed to respective frame supporting brackets 815 outside of the processing volume. More specifically, the light emitter 852 is affixed to the side of one frame supporting bracket 815, while the light receiver 854 is affixed to the side of another frame supporting bracket 815 on a diametrically opposite side of the substrate 850. Placing the sensing components 852, 854 on the frame inhibits the electronic components 852, 854 from being exposed to the wet environment of the chamber 800.

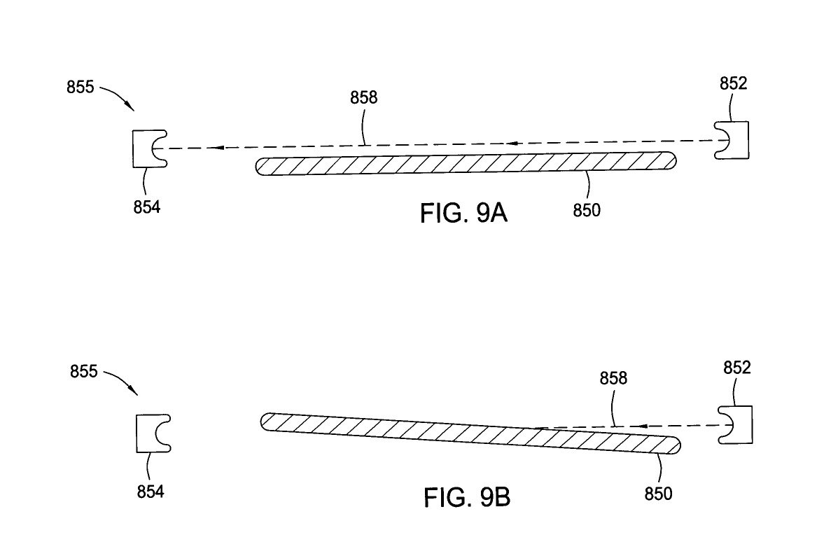

The light emitter 852 and the light receiver 854 are also shown in the schematic side views of FIGS. 9A and 9B. In these views, the opposing frame supporting brackets 815 are not shown, for clarity. Referring to FIGS. 9A and 9B, a light emitter 852 and a light receiver 854 are schematically shown in each drawing. Each component 852, 854 is disposed at a side of the substrate 850. The light emitter 852 is generating a light beam 858, while the light receiver 854 is ready to receive the light beam 858. Arrows are shown along the length of the respective light beam 858 in order to indicate the direction of travel of the beam 858. The light emitter 852 generates a beam of continuous light. Preferably, the light beam 858 is a laser beam. Any known laser beam generator is suitable for the light emitter 852. The light receiver 854 is able to sense the laser beam and convert it to a voltage or other electrically sensed property. Preferably, the light receiver 854 is a non-reflective or “thru-beam” type sensor. An example is the Model OSDK 10D9001 sensor manufactured by Baumer Electric. However, a reflective type of sensor could also be used.

The substrate sensing system 855 is set up such that the light beam 858 is delivered in a position that is immediately above the top surface of the substrate 850 when the substrate 850 is in its horizontal position. Stated another way, the light beam 858 is generated in a linear direction closely above the upper surface of the substrate 850 when the substrate 850 is properly placed on upper support surfaces 722 (not shown in FIGS. 9A and 9B) of the substrate support members 720. Preferably, the beam 858 is directed between about 1 mm and about 3 mm above the substrate, preferably about anticipated planar location of the upper substrate surface. Preferably, the light receiver 854 is disposed between about 200 mm and 300 mm from the light emitter, but this depends upon the size of the substrate 850 being processed, and the size of the chamber 800.

In FIG. 9A, the substrate 850 is shown in its proper horizontal position. This means that the substrate 850 is properly secured to the substrate support members 720 for processing. It will be understood that the substrate support members 720 will not be visible in the side view of FIG. 9A, as the light beam 858 must be offset from the respective positions of the substrate support members 720 to avoid interference. Because the substrate 850 of FIG. 9A is in its proper horizontal position, the light beam 858 generated by the light emitter 852 is able to be received by the light receiver 854. The presence of the light beam 858 causes a sensor in the light receiver to generate an electrical property, such as a voltage increase. This, in turn, tells the SRD system 100 to commence substrate processing operations.

Turning next to FIG. 9B, in FIG. 9B the substrate 850 has been misplaced, and is not in its proper horizontal position. This means that the substrate 850 has not been properly secured to the substrate support members 720. Because the substrate 850 of FIG. 9A is “out-of-pocket” or “out of horizontal,” the light beam 858 generated by the light emitter 852 is not able to be received by the light receiver 854, but is blocked by the non-horizontally positioned substrate 850. The absence of the light beam 858 prevents the SRD system 100 or its operator from commencing substrate processing operations. Those of ordinary skill in the art will appreciate that an out of pocket substrate can result in the destruction of the substrate and in severe damage to the chamber.

During a substrate sensing operation, it is possible that a substrate 850 could be out of pocket, but that the substrate sensing system 855 would not be able to detect it. This could occur where the plane of rotation about which the substrate is misaligned lines up with the direction of the beam 858. To account for this possibility, albeit remote, the operator may choose to check for substrate positioning twice. A first check would be conducted, and then, if the substrate was detected as being properly positioned, the substrate 850 would be rotated by approximately 90 degrees, and rechecked. Alternatively, two separate and radially offset substrate sensing systems could be employed.

In another embodiment of the invention, the substrate sensing assembly 855 may also be used to determine the presence of a substrate in the spin rinse dry cell of the invention. More particularly, the sensing assembly 855 may be configured such that the emitter 852 is positioned to send an optical signal through the plane of a substrate positioned in the cell for processing. Similarly, the detector or receiver 854 may be positioned to receive the optical signal. In this configuration, the sensing assembly 855 may be used to determine the presence of a substrate in the cell. More particularly, the emitter 852 may send a beam of light toward the plane of the substrate. If the receiver 854 detects the beam of light, then it is determined that a substrate is not present in the cell, as a substrate residing in the cell would have blocked the emitted light and not allowed it to be received by the receiver 854. As such, the sensing system 855 may also be used to determine the presence of a substrate in the processing system of the invention.

An exemplary spin rinse dry process may generally include a multi-step process. The first step (prerinse top) of the process includes rotating the substrate between about 900 rpm and about 1700 rpm, generally about 1300 rpm, for about 2 to about 6 seconds, while between about 1000 ml and about 1500 ml of a rinsing solution are dispensed onto the production surface or topside of the substrate. In another embodiment, the rotation rate of the pre-rinse step may be between about 100 rpm and about 130 rpm and DI may be dispensed for between about 1 and about 3 seconds. The second step (prerinse top and back) includes rotating the substrate between about 100 rpm and about 140 rpm while dispensing between about 1000 ml and about 1500 ml of rinsing solution onto the production surface and between about 600 ml and about 1000 ml of rinsing solution onto the backside of the substrate in about 6 seconds. The third step (backside clean) includes rotating at between about 40 rpm and about 90 rpm and dispending between about 200 ml and about 500 ml of chemistry, generally H₂O₂ and H₂SO₄, onto the backside of the substrate while dispensing between about 1000 ml and about 1500 ml of rinsing solution (which may be DI) onto the production surface for about 15 seconds, which generally operates to clean the backside of the substrate. The fourth step (post rinse) includes dispensing between about 1000 ml and about 1500 ml of rinsing solution onto the production surface, while dispensing between about 600 ml and about 1000 ml of rinsing solution onto the backside of the substrate while rotating at between about 40 rpm and about 90 rpm for between about 10 seconds and about 16 seconds.

In another embodiment of the invention the fourth step may be modified to include dispensing the post-rinse fluids onto the top and bottom of the substrate for between about 8 and about 12 seconds, while rotating the substrate at between about 175 and 225 rpm. Further, this step may include an additional post rinse step where only the topside of the substrate is rinsed, e.g., where the substrate is rotated at between about 175 and about 225 rpm for between about 8 and 12 seconds while additional rinsing solution is dispensed onto the topside of the substrate. The fifth step (bulk fluid spin off) includes terminating fluid flow to both sides and rotating the substrate between about 400 rpm and about 600 rpm for between about 3 seconds and about 6 seconds with a backside gas purge (nitrogen) flowing at a rate of between about 2 and about 4 cfm. In another embodiment of the invention, this step may be modified to rotate the substrate at a rate of between about 175 and about 225 rpm for between about 0.5 and about 2 seconds. The sixth step (bulk fluid spin off) includes rotating the substrate at between about 600 rpm and about 900 rpm while gas purging the backside of the substrate (nitrogen) at a flow rate of between about 2 and about 4 cfm for about 4 seconds. The seventh step (dry) includes rotating the substrate between about 1800 rpm and about 3000 rpm for between about 10 seconds and about 25 seconds with no gas and no fluid flow. In another embodiment of the invention, the drying gas (N₂) may be configured to trickle flow during each step of the process.

Additionally, the SRD cell of the invention is configured to generate an airflow pattern that prevents backflow or backsplash of the rinsing fluid onto the substrate, as this is known to hinder efficient drying of substrates. The SRD cell is configured to minimize backflow of air, i.e., flow of air toward the center of the substrate, via a catch cup shield 314 and a contoured outer surface 316 of the cell, as illustrated in FIG. 3. Specifically, the catch cup shield extends radially inward from the cell wall 309 and is positioned such that a distal terminating annulus of the shield 314 terminates at a point radially outward of the substrate and just below the lower surface of the substrate. The contoured portion of the wall 316 is shaped such that the upper portion of the contour terminates above the substrate and the lower terminating portion of the contour terminates below the lower surface of the substrate, generally into a backside or end opposite the annulus end of the catch cup 314. This configuration allows for the fluid that is spun off of the substrate to be received by the catch cup 314 and allowed to flow downward through the catch cup 314 via a plurality of holes formed therein. Additionally, the radially outwardly projecting (spiraling) airflow generated by the rotation of the substrate is also channeled above the catch cup and directed downwardly by the contoured surface 316. The airflow travels through the holes and may be evacuated from the chamber from below via a reduced pressure region 318. Therefore, the configuration of the SRD cell of the invention generates a radially outward airflow that does not reverse direction toward the center of the substrate, which prevents fluid mist from returning to the substrate surface and prolonging the drying process.

While the foregoing is directed to embodiments of the invention, other and further embodiments of the invention may be devised without departing from the basic scope thereof, where the scope thereof is determined by the claims that follow.

1. A substrate spin rinse dry cell, comprising:
a cell body defining an interior processing volume;
rotatable substrate support member positioned in the processing volume, the rotatable substrate support member comprising:
a rotatable flywheel having a plurality of upstanding substrate support members extending therefrom; and
a fixed central hub member positioned radially inward of the plurality of upstanding substrate engaging members, the central member having a plurality of backside fluid dispensing nozzles and at least one backside gas dispensing nozzle positioned thereon; and
at least one frontside fluid dispensing nozzle positioned to dispense a rinsing fluid onto an upper surface of a substrate supported by the substrate support members.

2. The spin rinse dry cell of claim 1, wherein each of the plurality of upstanding substrate support members comprise:
a pivotally mounted substrate engaging finger member; and
a fixedly mounted substrate support post member positioned in a channel formed into an inwardly facing surface of the substrate engaging finger member.

3. The spin rinse dry cell of claim 2, wherein the substrate engaging finger member further comprises a rounded leading edge having a first thickness and a tapering trailing edge portion having a second thickness, wherein the first thickness is greater than the second thickness.

4. The spin rinse dry cell of claim 2, wherein the substrate engaging finger member further comprises a horizontally positioned substrate engaging notch positioned proximate an upper terminating end of the finger member.

5. The spin rinse dry cell of claim 2, wherein the support post member further comprises a substantially horizontal substrate support surface having an angled substrate guide surface positioned radially outward of the substrate support surface.

6. The spin rinse dry cell of claim 2, wherein the pivotally mounted upstanding substrate engaging members are pivotally actuated via vertical movement of a shield member positioned in a lower portion of the spin rinse dry cell.

7. The spin rinse dry cell of claim 6, wherein the pivotally mounted substrate engaging finger members are configured to be actuated between an open position where a substrate may be loaded onto the support post members and a closed position where a bevel edge of the substrate is engaged by a horizontal channel formed into an inwardly facing surface of the finger member.

8. The spin rinse dry cell of claim 1, wherein the central hub member is rotatably fixed with respect to the rotatable substrate support member.

9. The spin rinse dry cell of claim 8, further comprising a at least two flow circulation breaker members attached to the central hub member and extending radially outward therefrom.

10. The spin rinse dry cell of claim 9, wherein the circulation breaker members are positioned to float above the substrate support member.

11. The spin rinse dry cell of claim 10, wherein the circulation breaker members are shaped with a tapered leading edge.

12. The spin rinse dry cell of claim 9, wherein the circulation breakers are sized and shaped to minimize formation of low pressure above the hub member during substrate rotation.

13. The spin rinse dry cell of claim 1, further comprising a substrate sensing assembly positioned outside the cell body.

14. The spin rinse dry cell of claim 13, wherein the substrate sending assembly comprises at least one light emitter and at least one light detector, the emitter being positioned to emit an optical signal parallel to and just above the surface of a substrate that is properly positioned in the spin rinse dry cell and the detector being positioned to receive the optical signal.

15. The spin rinse dry cell of claim 14, wherein the detector and emitter are positioned to determine presence and the planarity of the substrate relative to the substrate support members.

16. A substrate rinsing cell, comprising:
a rotatable flywheel having a plurality of substrate engaging finger assemblies extending therefrom, each of the plurality of finger assemblies having an outer pivotally mounted substrate engaging member and an inner fixed substrate supporting member;
at least one backside fluid dispensing nozzle positioned to dispense a rinsing fluid onto a backside of a; and
at least one frontside fluid nozzle positioned to dispense a rinsing fluid onto a frontside of the substrate positioned in a central opening at the flywheel.

17. The substrate rinsing cell of claim 16, further comprising at least one gas dispensing nozzle positioned to dispense a drying gas onto at least one of the frontside and the backside of the substrate.

18. The substrate rinsing cell of claim 16, wherein the plurality of finger assemblies comprise a rounded leading edge and a tapering trailing edge.

19. The substrate rinsing cell of claim 18, wherein the leading edge of the finger assemblies has a first diameter and the trailing edge of the finger assemblies has a second diameter, the first diameter being larger than the second diameter.

20. The substrate rinsing cell of claim 18, further comprising a horizontally positioned substrate engaging notch positioned proximate an upper terminating end of the finger assembly on an inwardly facing surface thereof.

21. The substrate rinsing cell of claim 16, wherein the outer pivotally mounted substrate engaging member is pivotally actuatable between a substrate loading position and a substrate processing position.

22. The substrate rinsing cell of claim 21, wherein the pivotally mounted substrate engaging member is pivotally actuated via vertical movement of a basin shield member positioned in a lower portion of the substrate rinsing cell.

23. The substrate rinsing cell of claim 16, wherein the fixed substrate support member comprises a post having an upper substantially horizontal substrate supporting surface and an inclined substrate centering surface positioned radially outward of the substrate supporting surface.

24. The substrate rinsing cell of claim 16, wherein the substrate engaging member has a vertical channel formed into an interior surface thereof, and the fixed substrate engaging member being positioned in the vertical channel.

25. The substrate rinsing cell of claim 16, further comprising a plurality of flow circulation breaker members positioned on a central fixed portion of the rotatable flywheel.

26. The substrate rinsing cell of claim 25, wherein the circulation breaker members comprise an elongated member extending radially outward from the central fixed member and extending upward from the flywheel toward the substrate.

27. The substrate rinsing cell of claim 26, wherein the circulation breaker members are float above the flywheel and are fixed to the central hub.

28. The spin rinse dry cell of claim 26, wherein the at least one circulation breaker is fabricated from at least one of a polymeric material, a plastic and polyetherimide.

29. The spin rinse dry cell of claim 26, wherein the at least one circulation breaker defines two fins extending radially from the hub in substantially opposite directions.

30. The substrate rinsing cell of claim 16, further comprising a substrate presence and planarity sensor.

31. The substrate rinsing cell of claim 30, wherein the sensor comprises an optical emitter and an optical detector, the emitter and detector being positioned to emit an optical signal through a plane of the substrate to determine the presence of the substrate and in a path parallel and proximate to a surface of the substrate to determine planarity of the substrate.

32. The substrate rinsing cell of claim 31, wherein the emitter and detector are positioned outside of a cell body containing the flywheel.

33. A method for rinsing and drying a substrate, comprising:
positioning the substrate on a plurality of post members;
pivoting a plurality of substrate engaging fingers radially inward to engage a bevel edge of the substrate;
dispensing a rinsing fluid onto at least one of a frontside and a backside of the substrate while rotating the substrate at a first rotation speed to rinse the substrate for a first period of time; and
rotating the substrate at a second rotation speed to dry the substrate for a second period of time, wherein the second rotation speed is greater than the first rotation speed.

34. The method of claim 33, further comprising dispensing a drying gas onto the substrate during the rotation at the second rotation speed.

35. The method of claim 33, wherein positioning the substrate on the plurality of fixed post members further comprises centering the substrate via slidable engagement between the substrate and an upwardly inclined surface positioned on an outer portion of the fixed post members.

36. The method of claim 33, wherein pivoting the fingers further comprises pivoting an airfoil shaped substrate engaging member inwardly to engage the substrate at a bevel edge portion thereof with a horizontally oriented notch formed into an inwardly facing surface of the airfoil member.

37. The method of claim 33, wherein rotating at the first rotation speed and the second rotation speed comprises rotating the substrate engaging fingers.

38. The method of claim 33, further comprising sensing the presence of the substrate after the pivoting step.

39. The method of claim 33, further comprising sensing the planarity of the substrate after the pivoting step.

40. The method of claim 33, further comprising reducing a low pressure region below the substrate by positioning at least one flow circulation breaker on a hub assembly below the substrate.

41. A spin rinse dry cell, comprising:
a rotatable flywheel assembly positioned in a cell body;
a stationary hub member positioned centrally in the flywheel;
a horizontal shield extending radially outward from the hub member over an upper surface of the flywheel; and
a vertical shield member positioned adjacent and parallel to a vertical side portion of the flywheel.

42. The spin rinse dry cell of claim 41, wherein the horizontal shield is positioned between about 1 mm and about 5 mm above the upper surface of the flywheel.

43. The spin rinse dry cell of claim 41, wherein the vertical shield comprises an annular member positioned radially outward of a perimeter of the flywheel, the annular member being positioned between about 1 mm and about 5 mm from the perimeter.
